(19) United States
(12) Patent Application Publication
(10) Pub. No.: US 2002/0170438 A1
(43) Pub. Date: Nov. 21, 2002

(54) High-pressure tea steep device

(76) Inventor: Tzeng-Shyang Liu, Taipei (TW)

Correspondence Address: TROXELL LAW OFFICE PLLC, 5205 LEESBURG PIKE, SUITE 1404, FALLS CHURCH, VA, 22041, US

(21) Appl. No.: 09/855,517

(22) Filed: May 16, 2001

(51) Int. Cl. A47J 31/00

(52) U.S. Cl. 99/293; 99/302 R

(57) ABSTRACT

The present invention is a high-pressure tea steep device which is mounted with a base body, the said base body is disposed with a boiler therein, a container is inserted onto a predetermined position of the said base body, the said container is communicated with the boiler via a conduit, a filter basket is situated inside the said container, and a plurality of pores are disposed on the bottom plane of the said filter basket; when in use, the pressured hot water in the boiler is poured toward the container through the conduit at a certain speed such that the hot water can evenly and rapidly pass through the tea leaf powder inside the filter basket and then discharge from the container, thereby enabling not only the accomplishment of the steeping work in an extremely short time, but also the extraction of the essence of the tea leaves.

### BACKGROUND OF THE INVENTION

1) Field of the Invention

The present invention is a high-pressure tea steep device, a device utilizing the pressuring method to pass the hot water through a container loaded with tea leaf powder that enabling the hot water to rapidly mix with the tea leaf powder inside the container and the extraction of the essence of the tea leaves, furthermore, accomplishing the tea steeping work in an extremely short time and making the steeped tea with better flavor than that generally requiring a certain period of steeping time.

2) Description of the Prior Art

Accordingly, the traditional way of tea steeping is to warm the teakettle first by the hot water, then to put a proper amount of tea leaves into the teakettle; after allowing the tea leaves to spread a little inside the warm teakettle, the hot water is poured into the teakettle; however, this method needs to steep tea leaves in the hot water for a certain period of time for making the tea leaves spread and the hot water permeate into the tea leaves, thereby to obtain tea mixed completely with the tea leaves; which not only takes a long steeping time, but also is not easy to control the length of time that usually ends either too short for the tea leaves to spread or so long that the flavor of the tea leaves loses and that is not very ideal.

In view of the mentioned shortcomings occurred during the conventional tea steeping process, the inventor of the present invention addressed the key problems and started to improve the coffee brewing device in order to search for a rational solution; however, since the filter basket of the said coffee brewing device is too small to load the amount of tea leaves needed for one steep and the handle bar of the container for accommodating the filter basket is not big and strong enough for the user to hold; following continuous research and design, the present invention of a high pressure tea steep device is finally culminated.

### SUMMARY OF THE INVENTION

The primary objective of the present invention is to provide a high pressure tea steep device, the said device is mounted with a base body, the said base body is disposed with a boiler therein, a container is inserted onto a predetermined position of the said base body, a filter basket is situated inside the said container, and a plurality of pores are disposed on the bottom plane of the said filter basket; when in use, a proper amount of ground tea leaf powder is loaded in the filter basket, then the container accommodated with the filter basket is inserted onto the base body; after making the said container into a sealed state, the pressured hot water in the boiler is poured toward the container at a certain speed such that the hot water can evenly and rapidly pass through the tea leaf powder inside the filter basket, thereby enabling not only the accomplishment of the steeping work in an extremely short time, but also the extraction of the essence of the tea leaves and, furthermore, the obtaining of tea full of the original flavor of the tea leaves.

Another objective of the present invention is to provide a high-pressure tea steep device wherein a handle bar can be installed to the container for facilitating the user's holding.

Yet another objective of the present invention is to provide a high-pressure tea steep device wherein the base body is mounted with a control valve thereby the control valve controls the steam pressure inside the boiler.

For further understanding of the technical method and effect adopted for achieving the mentioned objectives of the present invention, the brief description of the drawings below is followed by the detailed description of the preferred embodiment.

### BRIEF DESCRIPTION OF THE DRAWINGS

FIG. 1 is a pictorial drawing of the present invention.

FIG. 2 is a pictorial schematic drawing of the container and the filter basket of the present invention.

FIG. 3 is a cross-sectional schematic drawing of the present invention in embodiment.

FIG. 4 is another exemplary embodiment of the present invention.

### DETAILED DESCRIPTION OF THE PREFERRED EMBODIMENTS

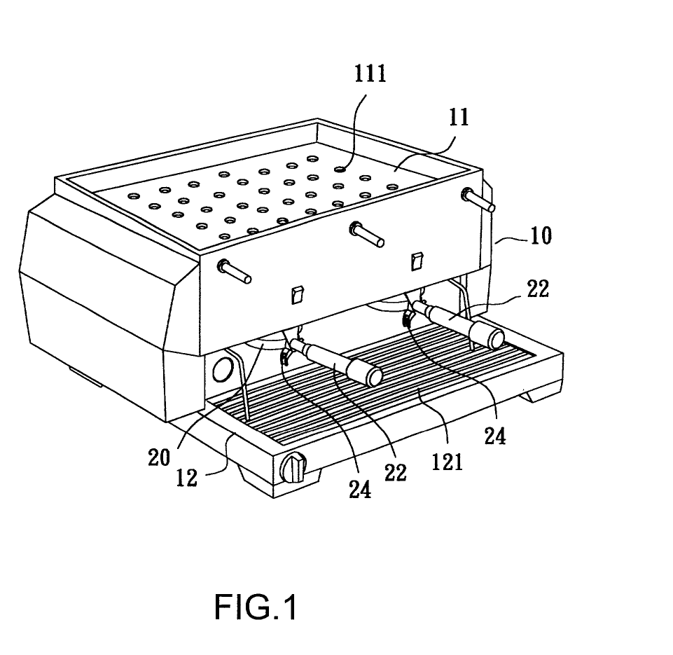

Referring to FIGS. 1, 2 and 3, as indicated, the present invention is a high-pressure tea steep device, the said device has a base body (10), a concaved receiving slot (11) is mounted on the top end of the said base body (10), a plurality of pores (111) are disposed on the said receiving slot (11), a water collecting slot (12) extending outward is mounted on the bottom portion of the said base body (10), a palisade (121) is disposed on the water collecting slot (12) for blocking the outside objects from falling into the water collecting slot (12).

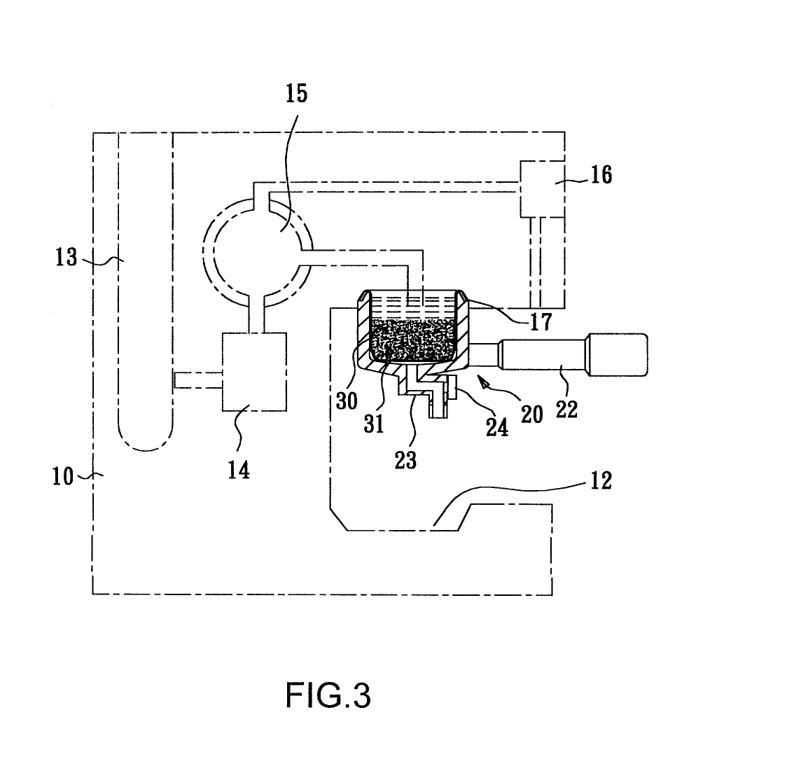

Referring to FIG. 3, as indicated, a cold water storage slot (13) is disposed inside the said base body (10) for storing the cold water; the said cold water storage slot (13) is connected to a pressure exchanger (14) via a conduit, the said pressure exchanger (14) is further conjoined to a boiler (15) via another conduit; when in use, the pressure exchanger (14) adds pressure to the cold water flowed from the cold water storage slot (13), then through the conduit connecting the pressure exchanger (14) and the boiler (15), the pressured cold water is delivered to the boiler (15); furthermore, the said boiler (15) connects to a pressure control valve (16) via a conduit, thereby the needed steam pressure can be controlled by the said pressure control valve (16).

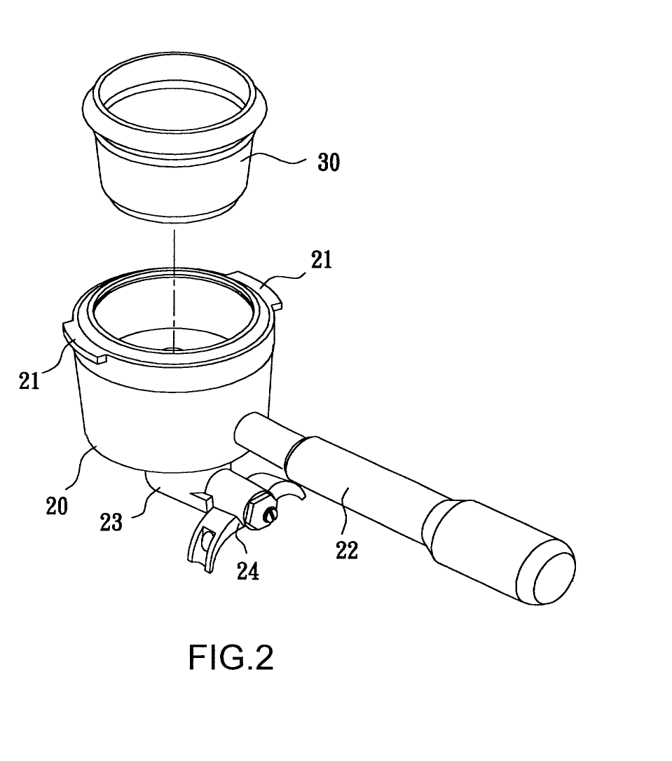

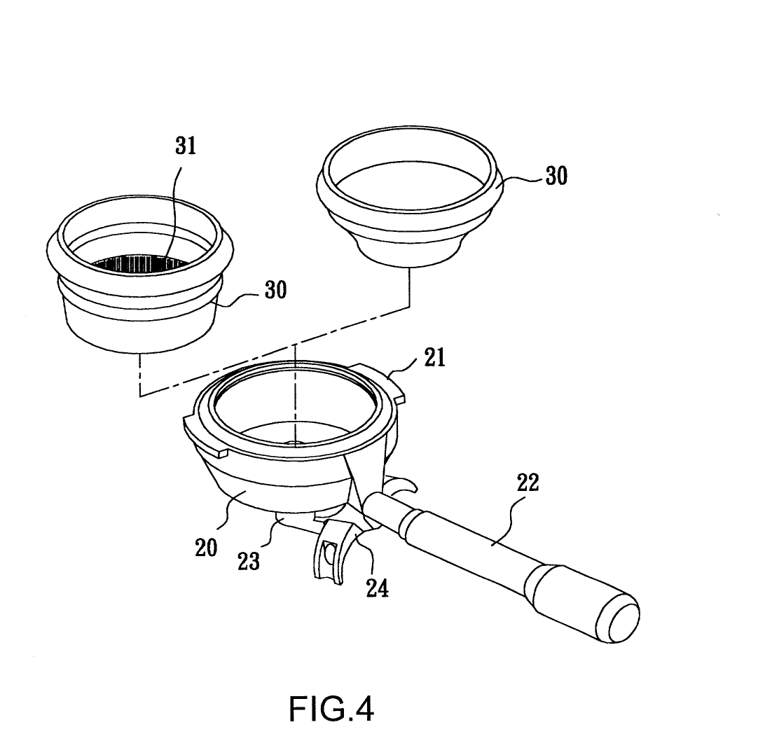

In addition, a insert slot (17) is mounted where the said base body (10) is relative to the water collecting slot (12), a container (20) is inserted onto the said insert slot (17), as indicated in FIG. 2, the convex insert rings (21) are situated on the periphery of the container (20) opening, the said insert rings (21) can fitly engage into the insert slot (17), and a handle bar (22) extending outward is conjoined onto the said container (20) for the user to hold; furthermore, a delivery pipe (23) extending outward is connected to the bottom end of the said container (20), a switch (24) is disposed on the said delivery pipe (23); the switch on and off of the switch (24) controls the flow of the liquid inside the container (20); furthermore, a fitted filter basket (30) is accommodated inside the container (20), the bottom portion of the said filter basket (30) is disposed with a plurality of designed filter pores (31), as indicated in FIG. 4, the said filter basket (30) can be designed into different volumes according to the need, also as indicated in FIG. 4.

When in use, referring to FIGS. 2 and 3, first the tea leaves will be ground into powder and a proper amount of tea leaf powder is loaded into the filter basket (30) (40g for this exemplary embodiment); the grain diameter must be smaller than that of the fine sugar, since too thick grain diameter of the powder causes too rapid speed of water flow and less extraction during steeping, furthermore, the flavor of the tea leaves can not be completely released; however, the grain diameter of the powder should not be as fine as that of the flour, otherwise it slows down the speed of water flow and further induces the bitter taste to come out; after the container (20) is inserted into the insert slot (17) of the base body (10), the cold water in the cold water storage slot (13) is pressured by the pressure exchanger (14) and flows into the boiler (15); the cold water is boiled by the boiler (15) and the boiler (15) is filled with hot water and steam; then due to the control of the pressure control valve (16), the steam pressure inside the boiler (15) is maintained at the needed pressure value (10 12 bars for this exemplary embodiment), through the conduit between the boiler (15) and the insert slot (17), the proper amount of hot water and steam inside the boiler (15) flow toward the filter basket (30) of the container (20) to steep for a certain period of timed and to allow the powdered tea leaves inside the filter basket (30) spread first and to provide a fluid bed with even and balanced anti-pressure for enabling the hot water in the boiler (15) to flow at a certain speed toward the container (20) and rapidly pass through the filter basket (30); then the switch (24) will be turned on to allow the hot water in the filter basket (30) to discharge, thereby enabling not only the accomplishment of the steeping work in an extremely short time, but also the extraction of the essence of the tea leaves and, furthermore, the obtaining of tea full of the original flavor of the tea leaves; milk can be added into the said tea to make milk-tea with unique taste.

In summation of the foregoing sections, the configuration, structure and device of the objects comprised in the present invention are of original innovation capable of improving all the shortcomings of the conventional technology, of being applied to steeping tea or other beverages and of enhancing the efficient usage; the present invention is practical, fully complies with all new patent requirements and is truly an ideal invention.

1. A high-pressure tea steep device comprises of:
a base body, inside the said base body a cold water storage slot is disposed for storing the cold water; the said cold water storage slot is connected to a pressure exchanger via a conduit, the said pressure exchanger is further conjoined to a boiler via another conduit; when in use, the pressure exchanger adds pressure to the cold water flowed from the cold water storage slot, then through the conduit connecting the pressure exchanger and the boiler, the pressured cold water is delivered to the boiler; furthermore, the said boiler is connected to a pressure control valve via a conduit thereby the needed steam pressure can be controlled by the said pressure control valve;
an container which is inserted onto the base body and communicated with the boiler;
an filter basket which is situated inside the container and has filter pores disposed on the bottom portion;
by virtue of the assembly of the mentioned mechanical component, when in use, a proper amount of ground tea leaf powder is loaded in the filter basket, then the container accommodated with the filter basket is inserted onto the base body; after making the said container into a sealed state, the pressured hot water in the boiler flows toward the container at a certain speed such that the hot water can evenly and rapidly pass through the tea leaf powder inside the filter basket, thereby enabling not only the accomplishment of the steeping work in an extremely short time, but also the extraction of the essence of the tea leaves and, furthermore, the obtaining of tea full of the original flavor of the tea leaves.

2. The high-pressure tea steep device of claim 1, wherein a handle bar is conjoined to the container for facilitating the user's holding.

3. The high-pressure tea steep device of claim 1, wherein a switch is mounted on the container for controlling the flow of the liquid inside the container.
